(19) United States
(12) Patent Application Publication
(10) Pub. No.: US 2013/0253823 A1
(43) Pub. Date: Sep. 26, 2013

(54) Method and Apparatus for Reducing Location Coordinate String Length

(71) Applicant: David M. Schardt, Milwaukee, WI (US)

(72) Inventor: David M. Schardt, Milwaukee, WI (US)

(21) Appl. No.: 13/895,516

(22) Filed: May 16, 2013

Related U.S. Application Data
(63) Continuation-in-part of application No. 12/632,153, filed on Dec. 7, 2009, now abandoned.

(51) Int. Cl. G01C 21/20

(52) U.S. Cl. CPC G01C 21/20
USPC 701/520

(57) ABSTRACT

The International Address System identifies a location with a combination of 10 alpha/numeric digits and does not need the input of the numeral zero or cardinal directions (i.e., north, south, east, west) to determine the location with a minimum accuracy of 129 square feet. The system utilizes a radix greater than 10 to improve accuracy without adding digits to accommodate existing displays. Such a system may be employed in hardware, software, or both, of a navigation system.

### CROSS REFERENCE TO RELATED APPLICATIONS

This non-provisional patent application is a continuation-in-part of U.S. Non-Provisional patent application Ser. No. 12/632,153, filed on Dec. 7, 2009, the entirety of which is expressly hereby incorporated by reference herein.

### STATEMENT REGARDING FEDERALLY SPONSORED RESEARCH OR DEVELOPMENT

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

1. Field of the Invention

The present inventive subject matter relates generally to a coordinate system for navigation, and more particularly to an improved International Address System.

2. Background

The presently existing navigation and positioning technology uses various forms of latitude and longitude (lat/long) coordinates, or alternatively an area's postal address system, to locate an exact position on the Earth. However, both of these methods have certain disadvantages for the average layperson.

Usage-wise, systems utilizing lat/long coordinates are not frequently used by lay people to locate a position due to several limiting factors. One factor is the complexity of the lat/long number system. Under this system, it generally takes seventeen or more digits and the use of cardinal directions to locate a position on the earth. Use of cardinal directions (i.e., north, south, east, and west) can be intimidating and disorienting for many users. For example, the current lat/long number system relies on the standard radix of ten in its character strings and a radix of two when considering the cardinal directions of either north or south and east or west. With current computer abilities, it may be beneficial to create a system that uses a radix greater than ten and remove the need for cardinal directions altogether.

Another complexity of the lat/long number system lies in the excessive precision of the current system. The number and values of the various lat/long digits changes frequently from destination to destination within a relatively small area. This can cause difficulty in pin-pointing a location.

Use of an area's postal address system is not any more accessible to the average lay person. If one is attempting to locate a position anywhere on the earth, the postal address systems currently in place for individual cities have several shortcomings. The most obvious among these is a lack of standardization between cities, and even within a city itself. This causes complications and errors in locating a position. Also, these address systems generally do not provide sufficient accuracy to locate loading docks or separate entrances at large facilities. Occasionally, the actual postal address of a building may be a relatively long distance from the entrance of the facility. These postal address systems do not allow for the location of different sites within a location (e.g., parking lots, tennis courts, hunting or camping spots, etc.) and these systems do not effectively locate new construction if media is not regularly updated. When using current postal address systems, one must also input a large quantity of data (e.g., state, city, zip code, street, street number) into navigation sources to locate a position, which can be time-consuming and frustrating.

U.S. Pat. No. 6,606,554 teaches a system of converting two or more existing universal and national coordinate systems into a single string of characters. The system requires more than ten digits to communicate a location within 129 square feet or less. The system cannot reduce the number of digits in the string without losing a degree of precision. It also teaches the conversion of cardinal directions into numerical values, then converting them back to cardinal directions after communications to use them as coordinates. Thus, the system still relies on the use of cardinal directions.

U.S. Pat. No. 7,089,022 teaches a method for obtaining information related to services within a certain area using a mobile communication device. The mobile communication device may download a menu of services based on a coarse determination of the position of the mobile device via GPS; however it does not provide an alternate coordinate system.

U.S. Pat. No. 6,047,236 teaches a method for defining grid and proprietary addresses of selected locations within a geographical area. The grid addresses are defined in relation to a grid and can be easily converted to global coordinates defined in relation to known global referencing system. However, the system does not provide an alternate coordinate system.

U.S. Patent Application No. 2008/0133124 teaches a method to identify a particular geographical location by means other than the postal address. However, these codes are unable to reduce the number of digits in the string without losing a degree of precision and often rely upon the use of cardinal directions.

A considerable need remains for inventive solutions that improve upon the current navigation and positioning systems in place. All patents and applications referred herein are incorporated by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

### SUMMARY OF THE INVENTION

The invention described herein is an international address system which assigns a unique value (i.e., address of location) based on the intersection of five digits for south-to-north (S/N) coordinates and five digits for east-to-west (E/W) coordinates. This address provides the end user with a more user-friendly, efficient way to communicate, locate, and navigate to an actual, physical location.

Additionally, the present invention uses a radix or base greater than 10 to reduce the number of digits required to communicate a location without reducing accuracy, and does not require the use of cardinal directions (i.e., north, south, east, and west). This system may be carried out by a non-transitory computer readable medium which stores the program to be performed, and a processor which operates the program conversions from memory. The system may be used in pre-existing navigation or GPS units.

Other features, advantages, and objects of the present invention will become more apparent and be more readily understood from the following detailed description, which should be read in conjunction with the accompanying drawings.

### BRIEF DESCRIPTION OF THE DRAWINGS

The present invention is illustrated by way of example, and not by way of limitation, in the figures of the accompanying drawings and in which like reference numerals refer to similar elements. Unless otherwise indicated illustrations in the figures are not necessarily drawn to scale.

FIG. 1 shows a perspective view of the Earth showing latitude lines dividing the Earth from south to north into its most significant digit;

FIG. 2 shows a cutaway view of the selected region of FIG. 1, showing the most significant digit as it would be divided by the next most significant digit;

FIG. 3 illustrates one embodiment of the present invention showing conversion for a radix of 35 where the numerical values of 0-34 equal the variables of A-Z and 1-9;

FIG. 4 shows a perspective view of the Earth's northern hemisphere showing the lines of longitude that divide the Earth into its most significant digit; and

FIG. 5 is a block diagram of system components for an embodiment of an apparatus usable with the methods of FIGS. 1-4.

### DETAILED DISCRIPTION OF THE INVENTION

Reference will now be made in detail to exemplary aspects of the present invention which are illustrated in the accompanying drawings. Wherever possible, the same reference numbers will be used throughout the drawings to refer to the same or like parts.

The present invention contemplates a system, method, and/or computer program code for expressing a geographical location or position based upon a number of digits representing south-to-north (S/N) coordinates and a number of digits for east-to-west (E/W) coordinates that does not require the use of cardinal directions, i.e., north, south, east or west. In one embodiment of the system, the system utilizes five (5) digits to represent the south-to-north coordinates and five (5) digits to represent the east-to-west coordinate. In this embodiment as well as others not specifically disclosed herein, a radix greater than ten (10) eliminates the need for cardinal directions and reduces the number of digits to ten (10) without reducing the precision of the location.

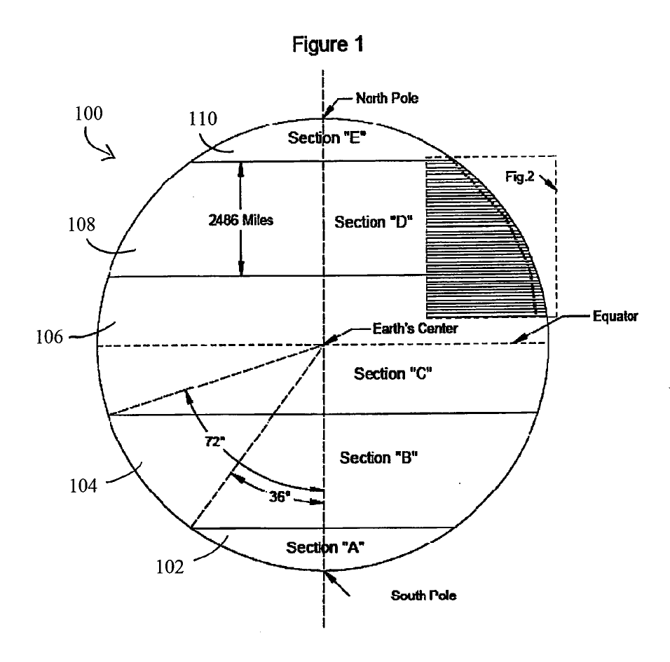

Referring to FIGS. 1-4, and demonstrating one embodiment of the present invention, the invention, referred to as the International Address System, has a combination of alpha/numeric digits in a string, which can include any suitable number of position-identifying digits, and in one embodiment the string can include from six (6) to twenty (20) digits, and in the illustrated embodiment includes ten (10) digits. The first five (5) digits of the string represent the south-to-north (S/N) coordinate and the last five (5) digits of the string represent the east-to-west (E/W) coordinate. A radix of 35 is used to eliminate the number of required digits where the numerical values of 0-34 equal or corresponding to the variables or digits of A-Z and 1-9. The ten (10) alpha/numeric digit code is defined as follows.

As represented in FIG. 1, the first digit is determined by dividing the Earth 100 into five 36-degree sections (102, 104, 106, 108, 110). Each section 102-110 is measured by determining a first thirty-six degree (36°) angle with one leg of the angle running from the South Pole to the vertex of the angle located at the Earth's center and the other leg spaced from the one leg and extending outwardly from the vertex at the Earth's center to form the thirty-six degree angle (36°) therebetween. Each successive section 104-110 is formed by determining additional thirty-six degree (36°) angles across one half of the circumference (180°) of the Earth, each section having one leg formed by the immediately adjacent leg of the adjacent section, and another leg spaced from the adjacent section at the thirty-six degree (36°) angle. The sections 102-110 are defined in this manner until reaching the final section 110 which has a leg extending from the North Pole to the Earth's center, which is directly opposite the first leg of the section 102. The intersections of the legs of each angle determined in this manner are then extended horizontally across the entire width of the Earth, thus delineating the five (5) horizontal sections 102-110 of the Earth. Each section (102, 104, 106, 108, 110) is labeled with a letter A-E starting from the section closest to the South Pole and moving toward the North Pole. This letter defines the first digit. By calculating from pole to pole of the Earth 100 and not from the equator, as in the current art, there is no need for the use of the cardinal directions of north and south.

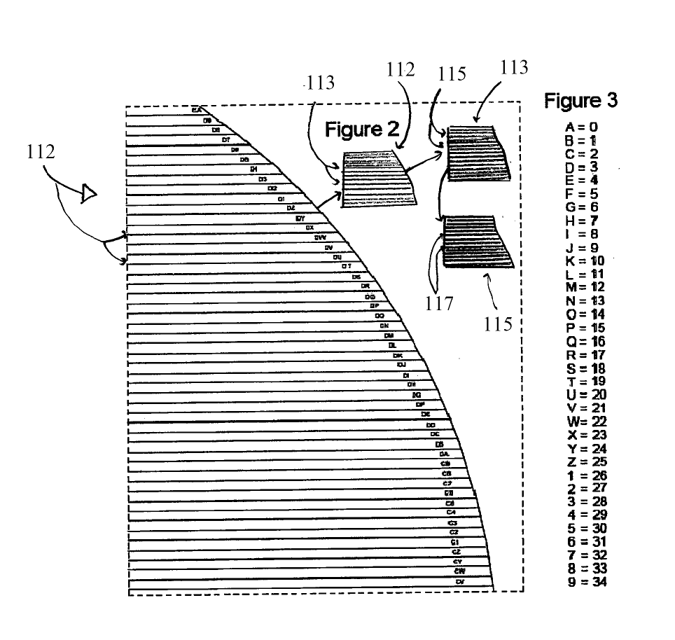

Referring to FIG. 2 is a cutout enlargement of a portion of FIG. 1 and shows how the second digit is determined. The 36-degree sections (102, 104, 106, 108, 110) created from the determination of the first digit are divided into thirty-five (35) equal subsections 112. Each of the thirty-five (35) subsections 112 are assigned a letter or number according to a radix of 35, as will be described in FIG. 3. This alpha/numeric digit for each subsection 112 is the second digit.

As also shown in FIG. 2, the third digit is determined by dividing each resulting subsection 112, resulting from the determination of the second digit, into thirty-five (35) equal subsections 113 again, forming subsections 113. Each of the thirty-five (35) subsections 113 are assigned a letter or number according to a radix of 35, as is shown in FIG. 3 and similar to that done for subsections 112. The assigned alpha/numeric digit for each subsection 113 represents the third digit.

As also shown in FIG. 2, the fourth digit is determined by dividing each previously generated subsection 113, resulting from the determination of the third digit, into thirty-five (35) equal subsections 115 one more time. Each of the thirty-five (35) subsections 115 are assigned a letter or number according to a radix of 35, as shown in FIG. 3 and similar to that done for subsections 112, 113. The assigned alpha/numeric digit represents the fourth digit.

Referring to FIG. 3, the method of assigning each of the thirty-five (35) subsections in sets 112, 113 and 115 an alpha/numeric digit is as follows. Each unit of thirty-five (35) sections 112, 113 and 115 is assigned a letter of A-Z (0=A, 1=B . . . 25=Z) followed by a numeric value of 1-9 (26=1, 27=2 . . . 34=9) when all the letters A-Z have been used. Therefore, each of the thirty-five (35) subsections 112, 113 and 115 is separately identified by an alpha/numeric digit, with each of the second to fourth digits having a radix of 35.

As shown in FIG. 2, the fifth digit is determined by dividing the section 115 represented by the fourth digit into twenty-six (26) subsections 117 and assigning each of these twenty-six (26) subsections 117 a letter from A-Z, respectively, such that the fifth digit has a radix of twenty-six (26). In this embodiment of the system, the five digit south-to-north (S/N) coordinate will always begin and end with a letter resulting from the identification of the sections 102-110 and of the sections 117 forming the first and fifth digits of the coordinate, respectively.

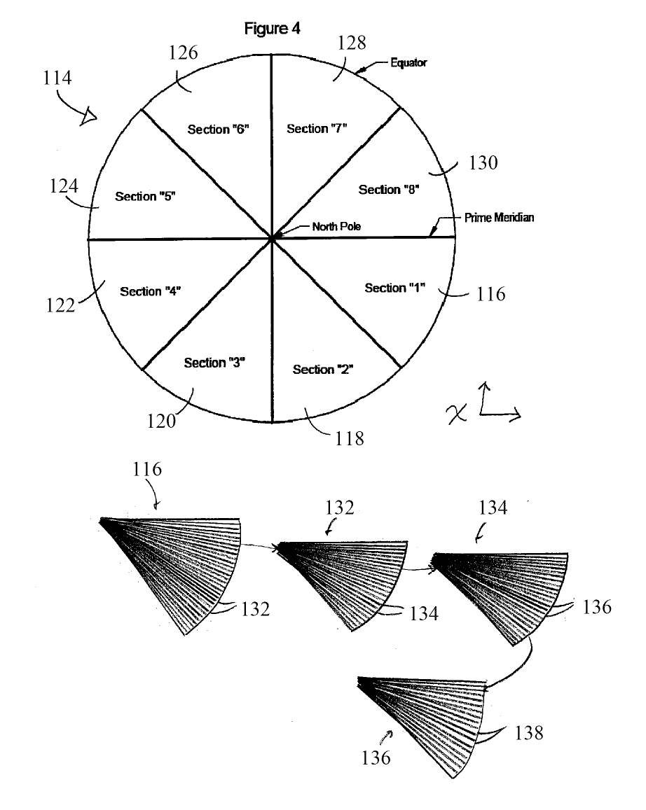

Referring to FIG. 4, the sixth thru tenth digits represent the east-to-west (E/W) coordinate. FIG. 4 shows the northern hemisphere 114 of the Earth and how in this embodiment the sixth digit is derived by dividing the entire circumference of the Earth into eight 45-degree sections (116, 118, 120, 122, 124, 126, 128, 130) which are sliced perpendicular to a plane “X” through the center of the Earth running east to west. These sections 116-130 are labeled with the numbers 1-8 starting with the Prime Meridian and moving eastward. As shown in FIG. 4, similarly to the process for determining the second through fifth digits of the south-to-north coordinate detailed above in FIG. 3, for the seventh thru ninth digits of the east-to-west coordinate, the sections 116-130 are each successively divided into thirty-five (35) equal subsections 132, which are also each divided into thirty-five (35) equal subsections 134, which are also divided into thirty-five (35) equal subsections 136, where each set of subsections 132, 134 and 136 are assigned a letter A-Z (0=A, 1=B . . . 25=Z) followed by a numeric value of 1-9 (26=1, 27=2 . . . 34=9), to produce the seventh through ninth digits each having a radix of thirty-five (35). Each subsection 136 is subdivided into twenty-six (26) equal subsections 138 labeled with a letter from A-Z, respectively, to provide the tenth digit having a radix of twenty-six (26) for the east-to-west coordinate, which will always begin with a numeric value.

The embodiment detailed above provides ten (10) digits (digits 1-5 for the south-to-north coordinate and digits 6-10 for the east-to-west coordinate, e.g., D2C4A 4KB5Z) that communicate a location with a minimum resolution or accuracy of 129 square feet as a result of the subdivision of the sections of the Earth 100 in the manner described above. Therefore, a location may be determined utilizing this coordinate system within an area of one hundred twenty-nine (129) square feet or less. In other embodiments, the number of subsections 112, 113, 115 and 117 for the south-to-north coordinate and the number of subsections 132, 134, 136 and 138 for the east-to-west coordinate can be altered in order to change the accuracy of the location or navigation system 200, as desired. For example, the radix for each corresponding digit in the coordinate other than the first and sixth digits can be selected to be at least above ten (10), preferably at least equal to or above fifteen (15), more preferably equal to or at least above twenty-six (26), and most preferably equal to or at least above thirty-five (35).

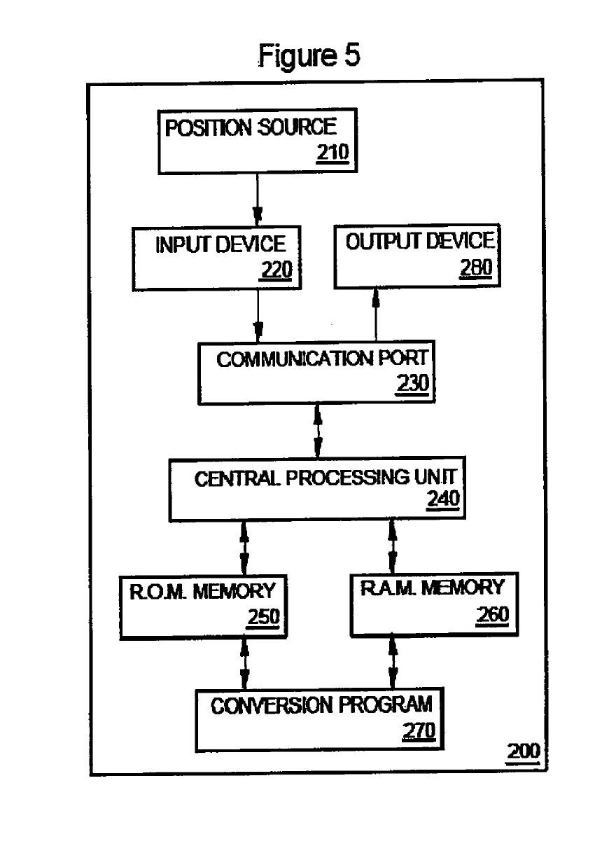

Referring to FIG. 5, this process uses a navigation or international address system 200 with non-transitory computer readable medium to store the information and a processor to operate the conversions from memory, as are generally known in the art. Some examples of a system 200 of this type are shown in U.S. Pat. No. 6,047,236 and U.S. Patent Application No. 2008/0133124, each of which is expressly incorporated herein by reference in its entirety. In another example, shown in FIG. 5, the non-transitory computer readable medium and processor may be found in a navigation system 200. A user may acquire their position on the earth from a position source 210 such as but not limited to, e.g., a GPS device, map, or survey. This position source 210 information is then the entered into an input device 220 and supplied to the central processing unit (CPU) 240 through a communication port 230. The CPU 240 uses read only memory (R.O.M. Memory) 250 and/or random access memory (R.A.M. Memory) 260 to store this information. The CPU 240 can then use a conversion program 270 stored in R.O.M. Memory 250 and/or R.A.M. Memory 260 (or optionally separate from but operably connected to the CPU 240, such as a wireless connection to a separate global positioning system database) to process this information into a unique character string for this location, as described in FIGS. 1-4. Based on the mathematical algorithms stored in the conversion program 270, some or all of the characters in the string may represent a numerical value with a radix greater than 10, such as in the embodiment where the digits represent a value having a radix of 35 corresponding to the particular subsection of the south-to-north or east-to-west coordinate. This character string can then be transmitted through the communication port 230 to an output device 280 for identification of the location.

If desired, the user may use the same output device 280 to convert the unique character string, which in the illustrated embodiment has ten (10) digits corresponding the to the south-to-north and east-to-west coordinates for the particular location, into a conventional base ten latitude and longitude system. Appropriate hardware and software elements are known to those skilled in the art. It should be noted that other hardware configurations are possible and not all of the components illustrated may be needed for other embodiments.

In addition, the number of digits used in the system 200 can be altered. For example, the most significant digits for south-to-north and east-to-west components can be combined into a single digit, thereby reducing the digit string for a particular location to nine (9) digits. Also, the system 200 can be set up to enable an individual to use a touch screen device 210 to mark a point of interest on a map displayed on the device. The system 200 can then determine the location of that point, which can be beneficial especially where the position does not have an existing postal address. This address from the system 200 can then be transmitted to another device, such as to provide another person with the location in order to enable that other person to obtain directions to the location. Further, it is also contemplated to group certain digits of the two strings together in combinations to create new strings for display by the system 200 other than simply the south-to-north and east-to-west coordinates. For example, it is contemplated to group similar significant digits from the two strings together to create a new string corresponding to a particular geographic region, similar to an area code, that represents a known area within which the remaining digits represent a particular location. Furthermore, if an embodiment of the system 200 is not required to provide a location with a precision of 129 square feet, as in the illustrated embodiment, the number of digits utilized in the location string can be varied to provide the desired precision or resolution to the location provided by the system 200. For example, if a larger area is sufficient for the location to be provided by the system 200, those digits in the string providing greater precision than that required can be left off of the string, as desired, resulting in a string that has fewer than the ten (10) digits in the illustrated embodiment. This optional resolution function can be hardwired into the system 200 to be fixed or to be variable based on user inputs.

Having fully described at least one embodiment of the present invention, other equivalent or alternative methods according to the present invention will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

What is claimed is:

1. A method for expressing a geographical location that comprises the steps of:
defining at least a first digit based upon a south to north coordinate; and
defining at least a second digit based upon an east to west coordinate;
wherein the first and second digits are based upon a radix greater than 10.

2. The method of claim 1 wherein the first and second digit are a combination of characters A through Z and numbers 0 through 9.

3. The method of claim 1 wherein the location is expressed by 10 or less digits.

4. The method of claim 1 wherein the location is expressed with an accuracy of 129 square feet or less.

5. A method for expressing a geographical location, comprising the steps of:
determining a coordinate location; and
converting the coordinate location into a string of digits;
wherein the string of digits is less than or equal to 10 digits and wherein at least one of the digits has a radix greater than 10.

6. The method of claim 5 wherein the radix of at least one digit is 35.

7. The method of claim 5 wherein the string of digits has 10 digits.

8. The method of claim 7 wherein the location is expressed with an accuracy of 129 square feet or less.

9. The method of claim 5 wherein the method does not include the use of cardinal directions.

10. A navigational apparatus comprising:
an input device by which a location address may be provided;
a storage device having a program performing the following steps:
defining at least a first digit based upon a south to north coordinate; and
defining at least a second digit based upon a east to west coordinate;
wherein the first and second digit are based upon a radix greater than 10;
a processor coupled to the input device and the storage device and performing the program based upon the location address; and
an output device wherein a location is provided by a string of numbers.

11. The apparatus of claim 10 wherein the string of numbers is defined by 10 digits or less.

12. The method of claim 10 wherein the location is expressed with an accuracy of 129 square feet or less.

13. The apparatus of claim 10 wherein the input device is a GPS system.
